(19) United States
(12) Patent Application Publication
(10) Pub. No.: US 2010/0155255 A1
(43) Pub. Date: Jun. 24, 2010

(54) PRETREATMENT PROCESS FOR ELECTROLESS PLATING OF RESIN MOLDED BODY, METHOD FOR PLATING RESIN MOLDED BODY, AND PRETREATMENT AGENT

(75) Inventors: Toshimitsu Nagao, Osaka-shi (JP); Yusuke Yoshikane, Osaka-shi (JP); Junji Yoshikawa, Osaka-shi (JP); Toru Morimoto, Osaka-shi (JP); Toshiya Murata, Osaka-shi (JP); Kazuya Satou, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OKUNO CHEMICAL INDUSTRIES CO., LTD., Osaka-shi, Osaka (JP)

(21) Appl. No.: 12/601,163

(22) PCT Filed: May 16, 2008
(86) PCT No.: PCT/JP2008/059075

§ 371 Date: Nov. 20, 2009

(30) Foreign Application Priority Data
May 22, 2007 (JP) 2007-135200

(51) Int. Cl. B05D 3/10; C09D 7/00

(52) U.S. Cl. 205/184; 427/444; 427/304; 106/316

(57) ABSTRACT

The present invention provides a pretreatment process for electroless plating of a resin molded article, comprising etching the resin molded article using a manganate salt-containing etching solution, and then bringing the resin molded article into contact with an aqueous solution containing a reducing compound and an inorganic acid; and a plating process of a resin molded article comprising the pretreatment process. Further, the present invention provides various treatment agents for use in the plating process. According to the present invention, a plating layer with sufficient adhesion can be formed when an etching treatment is performed using a manganate salt-containing etching solution in an electroless plating treatment of a resin molded article.

### TECHNICAL FIELD

The present invention relates to a pretreatment process for electroless plating of a resin molded article, comprising an etching treatment step using an etching solution containing a manganate salt; a plating process of a resin molded article comprising an etching treatment step using an etching solution containing a manganate salt; and a treatment agent used in the plating process.

### BACKGROUND ART

Resin molded articles have been used as automobile components in recent years to reduce the weight of automobiles. Resins such as ABS resins, PC/ABS resins, PPE resins, and polyamide resins have been used to achieve this object, and such resin molded articles are often plated with copper, nickel, or the like to provide high quality impressions and a beautiful appearance.

A common method for forming an electroplating film on a resin molded article comprises degreasing and etching the molded article, optionally followed by neutralization and pre-dipping, and then applying an electroless plating catalyst using a colloidal solution containing a tin compound and a palladium compound, optionally followed by activation (treatment with an accelerator), to perform electroless plating and electroplating sequentially.

In this case, for example, when an ABS resin is a substrate to be treated, a chromic acid mixture, which is a mixed solution of chromium trioxide and sulfuric acid, has been widely used as an etching solution. However, chromic acid mixtures, which contain toxic hexavalent chromium, adversely affect work environments. Moreover, safe disposal of the liquid waste requires reduction of the hexavalent chromium to a trivalent chromium ion, and then neutralization and precipitation, thus requiring complicated treatment for the disposal of the liquid waste. Therefore, in consideration of workplace safety and adverse effects of the liquid waste on the environment, avoiding the use of chromic acid-containing etching solution is preferable

Etching solutions that contain a manganate salt as an active ingredient are known as alternatives to chromic acid mixtures. As such etching solutions, an alkaline etching solution containing a permanganate salt and alkali metal hydroxide (see Non-patent Document 1 below), and an acidic etching solution containing a permanganate salt and inorganic acid (see Non-patent Document 2 below) are known. In etching a resin molded article using such etching solutions, however, inferior deposition of the electroless plating sometimes occurs during electroless plating that is performed after catalyst application, and further, a manganese component carried into a catalyst application solution adversely affects the deposition performance of the electroless plating. Accordingly, to allow the formation of a good electroless plating film in the case that etching treatment is performed using a manganate salt-containing etching solution, improvements in the treatment process are desired.

Non-patent Document 1: Surface technology manual, pp. 329, 1998, edited by the Surface Finishing Society of Japan
Non-patent Document 2: Basic and application of electroless plating, pp. 133, 1994, edited by Electric Plating Research Society

### DISCLOSURE OF INVENTION

### Technical Problem

The present invention was made in view of the state of the prior art. A primary object of the present invention is to provide a novel electroless plating process for a resin molded article, particularly, a process that is capable of forming a plating film with sufficient adhesion in the case that an etching treatment is performed using a manganate salt-containing etching solution in an electroless plating treatment of a resin molded article; and a treatment agent that is usable in the treatment process.

### Technical Solution

The present inventors conducted extensive research to achieve the above object. As a result, they found the following. When a resin molded article is etched using an etching solution containing a manganate salt as an active ingredient, and then subjected to a post-treatment using a treatment agent containing a reducing compound and an inorganic acid, manganate salts that are attached to the surface of the resin molded article during etching can be almost completely removed, which prevents a manganese component from entering into a catalyst solution, and ensures the formation of a good electroless plating film. The inventors further found that, when a surface-conditioning treatment using an amine compound is performed after the post-treatment, the amount of the adsorbed catalyst is increased, which allows stable production of a good plating film. Furthermore, the inventors found the following. In applying a catalyst on a substrate to be plated (i.e., catalyzing the substrate) with an acidic mixed colloidal solution containing palladium chloride and stannous chloride, activation is conducted after catalyst application, using a treatment agent that contains carboxylic acids, carboxylic acid salts, phosphorus compounds, carbonic acids, or a boric acid as active ingredients, which prevents deposition of electroless plating on the surface of a jig holding the resin molded article to be treated, enabling the formation of an electroless plating film only on the surface of the target resin molded article. Electroless plating and electroplating can be therefore performed sequentially without changing the jig, which simplifies the plating process. Based on the above findings, the present inventors conducted further research. The present invention was thus accomplished.

Specifically, the present invention relates to the following treatment process after etching of a resin molded article, plating process of a resin molded article, and treatment agent used in the processes.

Item 1. A pretreatment process for electroless plating of a resin molded article, the pretreatment process comprising etching the resin molded article using an etching solution containing a manganate salt, and then bringing the resin molded article into contact with an aqueous solution containing a reducing compound and an inorganic acid.

Item 2. The pretreatment process according to Item 1, wherein the etching solution containing a manganate salt is an aqueous solution containing 20 to 1,200 g/L of an inorganic acid, 0.01 to 40 g/L of a manganate salt, and 1 to 200 g/L of at least one member selected from the group consisting of halogen oxoacids, halogen oxoacid salts, persulfate salts, and bismuthate salts.

Item 3. A post-treatment agent of a resin molded article etched with an etching solution containing a manganate salt, the agent comprising an aqueous solution containing a reducing compound and an inorganic acid.

Item 4. A process for plating a resin molded article comprising the steps of:

(1) performing an etching treatment by bringing an etching solution containing a manganate salt into contact with the resin molded article;

(2) performing a post-treatment by bringing the resin molded article subjected to the etching treatment in step (1) into contact with a post-treatment agent comprising an aqueous solution containing a reducing compound and an inorganic acid;

(3) performing a surface conditioning by bringing the resin molded article subjected to the post-treatment in step (2) into contact with an aqueous solution containing an amine compound;

(4) applying an electroless plating catalyst after performing the surface conditioning in step (3); and

(5) performing electroless plating after applying the electroless plating catalyst in step (4).

Item 5. The process according to Item 4, wherein the aqueous solution containing an amine compound used in step (3) above comprises at least one member selected from the group consisting of ethyleneamines represented by the formula: H₂N(CH₂CH₂NH)ₙH, wherein n is an integer of 1 to 5, polyethyleneimines, and propylamines represented by the formula:

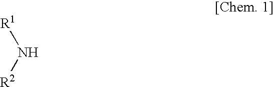

wherein R¹ is a propyl group or an aminopropyl group optionally having a substituent on nitrogen atom, and R² is a propyl group, an aminopropyl group optionally having a substituent on nitrogen atom, or a hydrogen atom.

Item 6. The process according to Item 4 or 5, wherein the process for applying an electroless plating catalyst in step (4) above comprises bringing the resin molded article into contact with a mixed colloidal solution containing 0.01 to 0.6 g/L of palladium chloride, 1 to 50 g/L of stannous chloride, and 100 to 400 ml/L of 35% hydrochloric acid, and then bringing the article into contact with an aqueous solution containing at least one member selected from the group consisting of carboxylic acids, carboxylic acid salts, phosphorus compounds, carbonic acid salts, and a boric acid.

Item 7. A process for plating a resin molded article comprising performing electroless plating by the process according to any one of Items 4 to 6, and then performing electroplating.

Item 8. The plating process according to any one of Items 4 to 7, wherein the manganate salt-containing etching solution is an aqueous solution containing 20 to 1,200 g/L of an inorganic acid, 0.01 to 40 g/L of a manganate salt, and 1 to 200 g/L of at least one member selected from the group consisting of halogen oxoacids, halogen oxoacid salts, persulfate salts, and bismuthate salts.

Item 9. A surface conditioning agent for use in a process for plating a resin molded article comprising an etching treatment step using a manganate salt-containing etching solution, the agent comprising an aqueous solution containing an amine compound.

Item 10. An activating agent for use in a catalyst application step of a process for plating a resin molded article comprising an etching treatment step using a manganate salt-containing etching solution, the agent comprising an aqueous solution containing at least one member selected from the group consisting of carboxylic acids, carboxylic acid salts, phosphorus compounds, carbonic acid salts, and a boric acid.

The process for plating a resin molded article using the treatment method of the present invention is described in detail below.

### Substrate to be Treated

In the treatment method of the present invention, a substrate to be treated is a resin molded article. The kind of the resin is not particularly limited. A particularly good electroless plating film can be formed on various resin materials that have heretofore been etched using a chromic acid-sulfuric acid mixture. More specifically, a good electroless plating film can be formed on styrene-based resins such as acrylonitrile-butadiene-styrene copolymer resins (ABS resins); resins having an acrylic rubber component (AAS resins) in place of the butadiene rubber component of ABS resin; resins having an ethylene-propylene rubber component (AES resins) in place of the butadiene rubber component of ABS resin; acrylonitrile-styrene copolymer resins (AS); polystyrene resins (PS); and the like. Alloy resins of styrene-based resins as mentioned above and polycarbonate (PC) resins (for example, alloy resins containing a PC resin in a proportion of about 30 to about 70 wt. %) are also preferable. It is also possible to use polyacrylonitrile resins (PAN), polycarbonate resins (PC), polyamido resins (PA), as well as Noryl, polyphenylene ether resins, polyphenylene oxide resins, and like resins that have excellent heat resistance and physical properties.

There is no specific limitation on the shape, size, etc. of the resin molded article. A good plating film with excellent appearance and physical properties can be formed even on a large article having a large surface area. Examples of such large resin products include automobile parts and accessories such as radiator grills, hubcaps, medium or small emblems, and door handles; exterior equipment used in the electrical or electronic field; faucet fittings used in places where water is supplied; game machine-related products such as pachinko components; and the like.

### Etching Treatment Step

In the present invention, etching is conducted using an etching solution containing a manganate salt as an active ingredient.

Examples of etching solutions containing a manganate salt as an active ingredient include alkaline etching solutions containing a permanganate salt and alkali metal hydroxide as active ingredients, acidic etching solutions containing a permanganate salt and an inorganic acid as active ingredients, and the like. All of such known etching solutions can be used in the present invention.

Usable examples of the alkaline etching solution include, but are not limited to, an aqueous solution containing about 40 to about 70 g/L of permanganate salts such as potassium permanganate and sodium permanganate, and about 10 to about 30 g/L of sodium hydroxide.

Usable examples of the acidic etching solution include, but are not limited to, an aqueous solution containing about 0.1 to about 50 g/L of permanganate salts such as potassium permanganate and sodium permanganate, and about 100 to about 600 g/L of inorganic acids, such as sulfuric acid, phosphoric acid, hydrochloric acid, and nitric acid.

Etching treatment using such etching solutions may be according to a known method.

In the present invention, it is preferable to use etching solution comprising an aqueous solution containing about 20 to about 1,200 g/L of an inorganic acid, about 0.01 to about 40 g/L of a manganate salt, and about 1 to about 200 g/L of at least one member selected from the group consisting of halogen oxoacids, halogen oxoacid salts, persulfate salts, and bismuthate salts. A good electroless plating film with high adhesion can be formed on a resin molded article by a process comprising etching the resin molded article using the etching solution described above, then applying an electroless plating catalyst, and subsequently performing electroless plating.

Among the active ingredients of the etching solution, examples of inorganic acids include sulfuric acid, hydrochloric acid, nitric acid, phosphoric acid, boric acid, carbonic acid, sulfurous acid, nitrous acid, phosphorous acid, borous acid, hydrogen peroxide, perchloric acid, and the like. Of these, sulfuric acid and hydrochloric acid are particularly preferable. Such inorganic acids can be used singly or in a combination of two or more. The content of the inorganic acid is about 20 to about 1,200 g/L, and preferably about 300 to about 1,000 g/L.

Among the active ingredients of the etching solution, particularly preferable as the manganate salts are permanganate salts. Permanganate salts are not particularly limited, as long as they are water-soluble salts. Examples of permanganate salts include sodium permanganate, potassium permanganate, and the like. Such manganate salts can be used singly or in a combination of two or more. The content of the manganate salts is about 0.01 to about 40 g/L, and preferably about 0.1 to about 10 g/L.

Among the active ingredients of the etching solution, examples of halogen oxoacids include hypohalous acid, halous acid, halogen acid, perhalogen acid, and the like. Examples of halogen oxoacid salts include water-soluble salts of the above-mentioned halogen oxoacids, such as sodium salts of halogen oxoacids, and potassium salts of halogen oxoacids. Examples of persulfate salts include water-soluble persulfate salts such as sodium persulfate, potassium persulfate, ammonium persulfate, and the like. Examples of bismuthate salts include water-soluble bismuthate salts such as sodium bismuthate, potassium bismuthate, and the like. Halogen oxoacids, halogen oxoacid salts, persulfate salts, and bismuthate salts can be used singly or in a combination of two or more. Particularly, at least one member selected from the group consisting of perhalogen acids such as perchloric acid, perbromic acid, and periodic acid, salts of these perhalogen acids, persulfate salts, and bismuthate salts is preferably used.

The etching solution should contain at least one member selected from the group consisting of halogen oxoacids, halogen oxoacid salts, persulfate salts, and bismuthate salts in an amount of about 1 to about 200 g/L, and preferably about 10 to about 100 g/L.

Preferable examples of the etching solutions include aqueous solutions containing: at least one inorganic acid selected from the group consisting of sulfuric acid and hydrochloric acid; at least one manganate salt selected from the permanganate salts; and at least one halogen oxoacid compound selected from the group consisting of perchloric acid, perbromic acid, periodic acid, and salts thereof.

For the etching treatment using the etching solution, the surface of the resin molded article, which is used as a substrate to be treated, is brought into contact with the etching solution. The method therefor is not particularly limited, as long as the method is capable of bringing the surface of the article into sufficient contact with the etching solution. For example, a method of spraying the etching solution over the article may be used. In general, efficient treatment can be achieved by immersion of the article into the etching solution.

The etching conditions are not particularly limited, and can be suitably selected according to the desired degree of etching. For example, when etching is performed by immersing the article into the etching solution, the temperature of the etching solution may be about 30° C. to about 70° C., and the immersion time may be about 3 to about 30 minutes.

When the surface of the resin molded article, which is used as a substrate to be treated, is extremely dirty, the surface may be degreased according to a usual method, prior to etching.

### Post-Etching Treatment Step

In the present invention, after etching, a post-treatment is carried out using an aqueous solution (sometimes referred to as a “post-treatment agent”) containing a reducing compound and an inorganic acid. This treatment allows efficient removal of manganese attached to the resin surface, thereby preventing manganese from entering into a catalyst solution, and improving the deposition performance of the electroless plating. As a result, a good electroless plating film with excellent uniformity can be formed.

In particular, when etching is performed using an etching solution comprising an aqueous solution containing inorganic acids, manganate salts, and at least one member selected from the group consisting of halogen oxoacids, halogen oxoacid salts, persulfate salts, and bismuthate salts, not only manganese but halogen compounds attached to the resin surface can be removed in an almost complete manner by performing a post-treatment using a post-treatment agent that contains a reducing compound and inorganic acid. Thus, the etching solution fully exhibits its excellent properties to thereby form a good electroless plating film with excellent uniformity and high adhesion.

Examples of reducing compounds contained in the post-treatment agent include polyvalent metal compounds having a reducing activity such as tin chloride, tin sulfate, iron chloride, and iron sulfate; saccharides such as glucose, mannitol, sucrose, fructose, maltose, and lactose; boron compounds such as sodium borohydride and dimethylamine borane; aldehyde compounds such as formaldehyde, acetaldehyde, propionaldehyde, acrolein, benzaldehyde, cinnamaldehyde, and perillaldehyde; ascorbic acids such as ascorbic acid, ascoryl stearate, sodium ascorbate, L-ascorbyl palmitate, and L-ascorbic-acid A glucoside; hydrazines such as hydrazine, hydrazine sulfate, hydrazine hydrochloride, hydrazine carbonate, hydrazine hydrobromide, hydrazine dihydrobromide; monocarboxylic acids such as formic acid, acetic acid, butyric acid, acrylic acid, palmitic acid, oleic acid, and glyoxylic acid, and salts thereof; dicarboxylic acids such as oxalic acid, malonic acid, succinic acid, glutaric acid, adipic acid, pimelic acid, suberic acid, azelaic acid, lepargilic acid, sebacic acid, and maleic acid, and salts thereof; aliphatic hydroxy acids such as lactic acid, tartaric acid, and citric acid, and salts thereof; hydroxylamines such as hydroxylamine sulfate, hydroxylamine hydrochloride, and hydroxylamine phosphate; sulfur-containing compounds such as sulfurous acid, thiosulfuric acid, and hydrogen sulfide; iodine-containing compounds such as silver iodide, potassium iodide, and sodium iodide; and the like. Such reducing compounds can be used singly or in a combination of two or more. Particularly, tin chloride, tin sulfate, ascorbic acid, sodium ascorbate, hydrazine sulfate, hydrazine hydrochloride, hydroxylamine sulfate, hydroxylamine hydrochloride, and thiosulfuric acid are preferable.

Examples of inorganic acids include sulfuric acid, hydrochloric acid, nitric acid, phosphoric acid, carbonic acid, nitrous acid, phosphorous acid, borous acid, hydrogen peroxide, perchloric acid, nitrogen peroxide, and the like. Such inorganic acids can be used singly or in a combination of two or more. Particularly, sulfuric acid and hydrochloric acid are preferable.

The concentration of the reducing compound in the post-treatment agent is preferably about 0.5 to about 100 g/L, and more preferably about 5 to about 30 g/L. The concentration of the inorganic acid is preferably about 5 to about 500 g/L, and more preferably about 30 to about 100 g/L.

The treatment method using a post-treatment agent is not particularly limited, as long as the method is capable of bringing the article into sufficient contact with the post-treatment agent. In general, efficient treatment can be achieved by immersion of the article into the post-treatment agent. In this case, the article may be immersed in a post-treatment agent having a temperature of about 20 to about 60° C. for about 1 to about 10 minutes.

### Conditioning (Surface Conditioning) Step

After performing the aforementioned post-treatment, if necessary, the surface of the article can be treated using an aqueous solution (hereinafter referred to as a “conditioning agent”) containing an amine compound. This treatment can increase the adsorption amount of the catalyst on the surface of the article used as a substrate to be treated, enabling the stable formation of a good plating film.

In particular, when a catalyst-accelerator method, i.e., a method comprising performing a catalyzing treatment using an acidic mixed colloidal solution (catalyst solution) containing palladium chloride and stannous chloride, and then performing an activation treatment, is used as a catalyst application method, the adsorption amount of the catalyst can be increased by conditioning the surface with the aforementioned conditioning agent even when the concentration of palladium in the catalyst solution is low. Moreover, this improves the deposition performance of the electroless plating, and the subsequent electroplating enables the formation of a plating film with a good appearance.

The amine compound contained in the conditioning agent may be at least one compound selected from the group consisting of ethyleneamines represented by formula: H₂N(CH₂CH₂NH)ₙH₂, wherein n is an integer of 1 to 5, polyethyleneimines, and propylamines represented by the following formula:

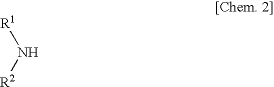

wherein R¹ is a propyl group or an aminopropyl group optionally having a substituent(s) on nitrogen atom; and R² is a propyl group, an aminopropyl group optionally having substituent(s) on nitrogen atom, or a hydrogen atom.

In the above formula, the propyl group may be either an n-propyl group or an isopropyl group. In the aminopropyl group optionally having a substituent(s) on nitrogen atom, examples of the substituents include lower alkyl groups such as methyl groups etc.

Of the amine compounds, examples of ethyleneamines include ethylenediamine, diethylenetriamine, triethylenetetramine, tetraethylenepentamine, pentaethylenehexamine, etc.

Polyethyleneimine, which is a water-soluble polymer obtained by polymerizing ethyleneimines, preferably has a number average molecular weight of about 300 to about 70,000, and more preferably about 600 to about 10,000.

Examples of propylamines include propylamine, isopropylamine, diisopropylamine, diaminopropylamine, methylaminopropylamine, dimethylaminopropylamine, etc. Of these, particularly preferable amine compounds are propylamine, isopropylamine, diaminopropylamine, etc. These amine compounds can be used singly or in a combination of two or more.

The content of the amine compound is preferably about 0.01 to about 50 g/L, and more preferably about 0.02 to about 10 g/L.

The surface conditioning method using the conditioning agent is not particularly limited. After performing post-etching treatment and washing with water, the resin molded article may be brought into contact with the conditioning agent. In general, efficient treatment can be achieved by immersion of the article into the conditioning agent. The treatment conditions are not particularly limited, but, for example, the article may be immersed in a conditioning agent of about 10 to about 40° C., for about 0.5 to about 5 minutes.

The pH of the conditioning agent is not particularly limited. However, when the resin molded article is formed of two types of resins that include a portion on which a plating film should not be deposited, or when the resin molded article include a non-plating portion on which a plating resist film is formed, selective deposition of the plating film only on a target resin surface is required. In this case, the pH is preferably about 12 or less, and more preferably about 8 or less; the lower limit of the pH is preferably about 4. Within such a pH range, the plating film can be formed with high selectivity. When the pH is adjusted to the above range, a buffer may be added to suppress the change in pH caused by the introduction of the etching solution into the conditioning agent. Examples of buffers include carbonic acid, boric acid, phosphoric acid, phosphorous acid, oxalic acid, acetic acid, malonic acid, malic acid, citric acid, glycolic acid, gluconic acid, succinic acid, glycine, nitrilodiacetic acid, nitrilotriacetic acid, 2-aminoethanol, diethanolamine, triethanolamine, and salts thereof, etc. Such buffers can be used singly or in a combination of two or more.

The content of the buffer is not particularly limited. In general, it is preferably about 1 to about 50 g/L.

### Catalyst Application Process

After performing the etching treatment and post-treatment, and optionally performing the conditioning (surface conditioning) treatment, a catalyst for electroless plating is applied.

The process for applying an electroless plating catalyst is not particularly limited. An electroless plating catalyst such as palladium, silver, ruthenium, or the like may be applied according to a known method. For example, known processes of applying a palladium catalyst include the so-called catalyst-accelerator method, sensitizing-activating method, alkali catalyst method, and the like.

Among these, the catalyst-accelerator method is particularly preferable since the plating film is likely to be deposited on the resin molded article in a uniform manner.

As a catalyst solution, a commonly used acidic mixed colloidal solution containing palladium chloride and stannous chloride is usable. For example, an acidic mixed colloidal solution containing about 0.01 to about 0.6 g/L of palladium chloride, about 1 to about 50 g/L of stannous chloride, and about 100 to about 400 ml/L of 35% hydrochloric acid can be used. A treatment method using the catalyst solution involves immersion of the resin molded article in the catalyst solution of about 20 to about 40° C., for about 1 to about 10 minutes. After catalyst treatment, activation may be conducted using an aqueous sulfuric acid solution, aqueous hydrochloric acid solution, aqueous alkali-metal hydroxide solution, and like accelerator solutions, according to a usual method. Specific treatment processes and conditions of the aforementioned method are according to known methods.

In the present invention, particularly by employing as a catalyst application process, the process comprising catalyzing a substrate to be treated using a catalyst solution comprising a mixed colloidal solution containing about 0.01 to about 0.6 g/L of palladium chloride, about 1 to about 50 g/L of stannous chloride, and about 100 to about 400 ml/L of 35% hydrochloric acid, and then activating the substrate using an aqueous solution (hereinafter sometimes referred to as “activating agent”) containing at least one member selected from the group consisting of carboxylic acids, carboxylic acid salts, phosphorus compounds, carbonic acid salts, and a boric acid, the catalyst component attached on the surface of the jig coated by a flexible vinyl chloride sol can be almost completely removed, which prevents the deposition of the electroless plating on the surface of the jig. As a result, electroless plating and electroplating can be performed sequentially without changing the jig, largely simplifying the process.

Examples of carboxylic acids contained in the activating agent include monocarboxylic acids, such as formic acid, acetic acid, propionic acid, methylacetic acid, butyric acid, ethylacetic acid, n-valeric acid, n-butanecarboxylic acid, acrylic acid, propiolic acid, methacrylic acid, palmitic acid, stearic acid, oleic acid, linolic acid, and linolenic acid; dicarboxylic acids, such as oxalic acid, malonic acid, succinic acid, glutaric acid, adipic acid, pimelic acid, suberic acid, azelaic acid, lepargilic acid, sebacic acid, maleic acid, and fumaric acid; aliphatic hydroxy acids, such as glycolic acid, lactic acid, tartronic acid, glyceric acid, malic acid, tartaric acid, citramalic acid, citric acid, isocitric acid, leucine acid, mevalonic acid, pantoic acid, recinoleic acid, ricinelaidic acid, cerebronic acid, quinic acid, and shikimic acid; aromatic hydroxy acids, such as salicylic acid, creosote acid, vanillic acid, syringic acid, pyrocatechuic acid, resorcylic acid, protocatechuic acid, gentisic acid, orsellinic acid, gallic acid, mandelic acid, benzilic acid, atrolactinic acid, melilotic acid, phloretic acid, coumaric acid, umbellic acid, caffeic acid, ferulic acid, and sinapic acid; etc. Salts of such carboxylic acids are not particularly limited, as long as they are water-soluble salts. Examples thereof include sodium salts, potassium salts, and like alkali metal salts, ammonium salts, etc. Examples of phosphorus compounds include trisodium phosphate, potassium phosphide, potassium pyrophosphate, sodium pyrophosphate, etc. Examples of carbonic acid salts include ammonium carbonate, potassium carbonate, potassium hydrogen carbonate, calcium carbonate, sodium hydrogen carbonate, sodium carbonate, barium carbonate, etc.

In the activating agent, the concentration of at least one member selected from the group consisting of carboxylic acids, carboxylic acid salts, phosphorus compounds, carbonic acid salts, and a boric acid is preferably about 1 to about 100 g/L, and more preferably about 5 to about 50 g/L. To perform a treatment using an activating agent, the substrate may be immersed in the activating agent of about 30 to about 50° C. for about 1 to about 7 minutes.

Prior to application of a catalyst, pre-dipping can be performed using an aqueous hydrochloric acid solution, according to a usual method. Thereby, it is possible to prevent a pretreatment agent from entering into a catalyst application solution.

Pre-dipping may be performed by immersing the substrate in an aqueous solution containing about 20 to about 300 ml/L of 35% hydrochloric acid at a temperature of about 15 to about 30° C., for about 0.5 to about 3 minutes. However, the conditions are not limited thereto.

### Plating Process

A highly uniform electroless plating film having a good adhesion can be formed on the surface of the resin molded article by performing the electroless plating after applying the catalyst according to the above-mentioned method.

The electroless plating solution may be any known autocatalytic electroless plating solution. Examples of such electroless plating solutions include electroless nickel plating solutions, electroless copper plating solutions, electroless cobalt plating solutions, electroless nickel-cobalt alloy plating solutions, electroless gold plating solutions, and the like.

The electroless plating conditions may be according to known methods. If necessary, two or more layers of electroless plating film may be formed.

After the electroless plating, electroplating may be further performed. In this case, after the electroless plating, activation may be optionally performed using an aqueous solution of an acid, alkali or the like, and then electroplating is performed. The kind of electroplating solution is not particularly limited. The electroplating solution can be suitably selected from known electroplating solutions according to the purpose.

According to the above method, a highly uniform plating film with an extremely high adhesion can be formed on a resin molded article.

### ADVANTAGEOUS EFFECTS

According to the plating process that comprises etching a resin molded article using a manganate salt-containing etching solution, and then treating the resin molded article using the post-treatment agent of the present invention, the following remarkable effects can be achieved.

(1) When the etching treatment is performed using the manganate salt-containing etching solution which is a highly safe etching treatment agent, the residual material of the etching solution is efficiently removed. Thus, a highly uniform plating film can be formed. Further, it is possible to prevent manganese from entering into a catalyst solution.

(2) When an aqueous solution containing inorganic acids, manganate salts, and at least one member selected from the group consisting of halogen oxoacids, halogen oxoacid salts, persulfate salts, and bismuthate salts is used as an etching solution, the resulting plating film is particularly excellent in adhesion.

(3) When surface conditioning is performed using an aqueous solution containing an amine compound prior to catalyst application, the amount of the adsorbed catalyst is increased, allowing stable formation of a good plating film. Particularly, when the catalyst-accelerator method is employed as a catalyst application method, a plating film with excellent uniformity can be formed on a resin molded article by conditioning the surface with an amine compound.

(4) When a process comprising catalyzing a substrate to be plated using as a catalyst solution an acidic mixed colloidal solution containing palladium chloride and stannous chloride, and then activating the substrate using an aqueous solution containing at least one member selected from the group consisting of carboxylic acids, carboxylic acid salts, phosphorus compounds, carbonic acid salts, and a boric acid is employed as a catalyst application method, the deposition of the electroless plating on the jig holding the substrate can be prevented. As a result, electroless plating and electroplating can be performed sequentially without changing the jig, simplifying the treatment process.

### BEST MODE FOR CARRYING OUT THE INVENTION

The present invention will be described below in more detail with reference to the Examples.

### Example 1

Using a flat plate (10 cm×5 cm×0.3 cm, surface area: about 1 dm²) made of an ABS resin (trade name: “CYCOLAC 3001M”; product of UMG ABS, Ltd.) as a substrate to be treated, the treatment according to an immersion method was performed following the procedure as shown in Table 1 below, to thereby obtain an electroless plating film. Post treatment of etching was conducted using post-treatment agents shown in Tables 2 and 3 below. Washing was conducted between each step.

TABLE 1

| Treatment | Kind of treatment agent | | | Treatment condition | | |
|---|---|---|---|---|---|---|
| procedure | Component | Content | | Temperature | time | |
| Degreasing | Alkaline degreasing | 50 | g/L | 40° C. | 3 | min. |
| | solution (“ACE CLEAN | | | | | |
| | A-220”; produced by | | | | | |
| | Okuno Chemical | | | | | |
| | Industries Co., Ltd.) | | | | | |
| ↓ | | | | | | |
| Etching | Potassium permanganate | 0.5 | g/L | 65° C. | 10 | min. |
| | Sodium perchlorate | 5 | g/L | | | |
| | 98% Sulfuric acid | 250 | ml/L | | | |
| ↓ | | | | | | |
| Post- | Post-treatment agent in Tables 2 | | | 50° C. | 5 | min. |
| treatment | and 3 | | | | | |
| ↓ | | | | | | |
| Conditioning | Ethylenediamine | 5 | g/L | 25° C. | 1 | min. |
| ↓ | | | | | | |
| Catalyst | Palladium chloride | 100 | mg/L | 35° C. | 3 | min. |
| Application | Stannous chloride | 5 | g/L | | | |
| | 35% Hydrochloric acid | 150 | ml/L | | | |
| | ↓ | | | | | |
| | 98% Sulfuric acid | 100 | ml/L | 40° C. | 3 | min. |
| ↓ | | | | | | |

| | | | | |
|---|---|---|---|---|
| Electroless | Electroless nickel plating | 40° C. | 10 | min. |
| plating | (“Chemical Nickel A, B”; | | | |
| | produced by Okuno Chemical | | | |
| | Industries Co., Ltd.) | | | |

TABLE 2

| | | Post-treatment agent of the present invention | | | | | | | | | |
|---|---|---|---|---|---|---|---|---|---|---|---|
| | | 1 | 2 | 3 | 4 | 5 | 6 | 7 | 8 | 9 | 10 |
| Reducing | Glucose (g/L) | 20 | | | | | | | | | |
| Compound | Hydrazine (g/L) | | 20 | | | | | | | | |
| | Ascorbic acid (g/L) | | | 20 | | | | | | | |
| | Citric acid (g/L) | | | | 20 | | | | | | |
| | Sodium borohydride (g/L) | | | | | 20 | | | | | |
| | Tin chloride (g/L) | | | | | | 20 | | | | |
| | Formaldehyde (g/L) | | | | | | | 20 | | | |
| | Hydroxylamine hydrochloride (g/L) | | | | | | | | 20 | | |
| | Sodium thiosulfate (g/L) | | | | | | | | | 20 | |
| | Potassium iodide (g/L) | | | | | | | | | | 20 |

| | | | | | | | | | | |
|---|---|---|---|---|---|---|---|---|---|---|
| Hydrochloric acid (g/L) | 100 | 100 | 100 | 100 | 100 | 100 | 100 | 100 | 100 | 100 |

TABLE 3

| | | Comparative post-treatment agent | | | | | | | | | |
|---|---|---|---|---|---|---|---|---|---|---|---|
| | | 1 | 2 | 3 | 4 | 5 | 6 | 7 | 8 | 9 | 10 |
| Reducing | Glucose (g/L) | | 20 | | | | | | | | |
| compound | Hydrazine (g/L) | | | 20 | | | | | | | |
| | Ascorbic acid (g/L) | | | | 20 | | | | | | |
| | Citric acid (g/L) | | | | | 20 | | | | | |
| | Formaldehyde (g/L) | | | | | | 20 | | | | |
| | Tin chloride (g/L) | | | | | | | 20 | | | |
| | Potassium iodide (g/L) | | | | | | | | 20 | | |

| | | |
|---|---|---|
| Hydrochloric acid (g/L) | 100 | |
| Sulfuric acid (g/L) | | 100 |

Using the aforementioned post-treatment agent, electroless nickel plating was performed according to the procedure as shown in Table 1. The percentage of the electroless plating film formed on the resin molded article was measured to evaluate the deposition performance of electroless plating. Further, after performing the post-treatment, the amounts of manganese and halogen adsorbed on the surface of the resin molded article were measured according to the ICP emission spectrochemical analysis. The results are shown in Table 4 below.

TABLE 4

| | | | Adsorption amount of | Adsorption amount of |
|---|---|---|---|---|
| | | Deposition | manganese on the | halogen on the |
| | | performance of | resin surface after | resin surface after |
| | | the electroless | reducing treatment | reducing treatment |
| | | plating | (mg/dm²) | (mg/dm²) |
| Post- | 1 | Full | 0.0092 | Undetected |
| treatment | | deposition | | |
| agent of | 2 | Full | 0.0009 | Undetected |
| the present | | deposition | | |
| invention | 3 | Full | 0.0051 | Undetected |
| | | deposition | | |
| | 4 | Full | 0.0044 | Undetected |
| | | deposition | | |
| | 5 | Full | 0.0032 | Undetected |
| | | deposition | | |
| | 6 | Full | 0.0073 | Undetected |
| | | deposition | | |
| | 7 | Full | 0.0037 | Undetected |
| | | deposition | | |
| | 8 | Full | 0.0047 | Undetected |
| | | deposition | | |
| | 9 | Full | 0.0013 | Undetected |
| | | deposition | | |
| | 10 | Full | 0.0040 | Undetected |
| | | deposition | | |
| Comparative | 1 | 10% Deposition | 0.9400 | 1.213 |
| post- | 2 | 30% Deposition | 0.0039 | 1.3991 |
| treatment | 3 | 35% Deposition | 0.0059 | 1.4261 |
| agent | 4 | 15% Deposition | 0.0082 | 1.0023 |
| | 5 | 10% Deposition | 0.0046 | 1.4282 |
| | 6 | 10% Deposition | 0.0083 | 1.7293 |
| | 7 | 20% Deposition | 0.0099 | 1.2701 |
| | 8 | 10% Deposition | 0.0079 | 1.0021 |
| | 9 | 20% Deposition | 1.0208 | 1.0434 |
| | 10 | 20% Deposition | 1.2544 | 1.3200 |

As is clear from the above results, when the post-treatment of etching is performed using the post-treatment agent of the present invention containing a reducing compound and an inorganic acid, the amounts of manganese and halogen adsorbed on the resin surface are remarkably reduced, enabling the production of a uniform electroless plating film.

### Example 2

Using a flat plate (10 cm×5 cm×0.3 cm, surface area: about 1 dm²) made of an ABS resin (trade name: “CYCOLAC 3001M”; product of UMG ABS, Ltd.) as a substrate to be treated, the treatment according to an immersion method was conducted following the procedure as shown in Table 5 below to perform electroless plating and electroplating. Treatment agents shown in Table 6 below were used as conditioning agents. Washing was conducted between each step.

TABLE 5

| Treatment | Kind of treatment agent | | | Treatment condition | | |
|---|---|---|---|---|---|---|
| procedure | Component | Content | | Temperature | time | |
| Degreasing | Alkaline degreasing | 50 | g/L | 40° C. | 3 | min. |
| | solution (“ACE CLEAN | | | | | |
| | A-220”; produced by | | | | | |
| | Okuno Chemical | | | | | |
| | Industries Co., Ltd.) | | | | | |
| ↓ | | | | | | |
| Etching | Potassium permanganate | 0.5 | g/L | 65° C. | 10 | min. |
| | Sodium perchlorate | 5 | g/L | | | |
| | 98% Sulfuric acid | 250 | ml/L | | | |
| ↓ | | | | | | |
| Post- | Glucose | 50 | g/L | 50° C. | 5 | min. |
| treatment | 35% Hydrochloric acid | 150 | ml/L | | | |
| ↓ | | | | | | |
| Conditioning | Conditioning agent in Table 6 | | | 25° C. | 1 | min. |
| ↓ | | | | | | |
| Pre-dipping | 35% Hydrochloric acid | 250 | ml/L | 25° C. | 1 | min. |
| ↓ | | | | | | |
| Catalyst | Palladium chloride | 330 | mg/L | 35° C. | 6 | min. |
| Application | Stannous chloride | 35 | g/L | | | |
| | 35% Hydrochloric acid | 250 | ml/L | | | |
| | ↓ | | | | | |
| | Lactic acid | 50 | g/L | 40° C. | 3 | min. |
| ↓ | | | | | | |
| Electroless | Electroless copper plating (“CRP | | | 45° C. | 3 | min. |
| plating | selector”; produced by Okuno | | | | | |
| | Chemical Industries Co., Ltd.) | | | | | |
| ↓ | | | | | | |
| Copper | Copper sulfate | 250 | g/L | 25° C. | 1.5 | A/dm² |
| sulfate | 98% Sulfuric acid | 50 | g/L | | 5 | min. |
| electro- | Chlorine ion | 50 | ppm | | | |
| plating | CRP Copper MU (produced | 5 | ml/L | | | |
| | by Okuno Chemical | | | | | |
| | Industries Co., Ltd.) | | | | | |
| | CRP Copper A (produced | 0.5 | ml/L | | | |
| | by Okuno Chemical | | | | | |
| | Industries Co., Ltd.) | | | | | |

TABLE 6

| Conditioning Agent | 1 | 2 | 3 | 4 | 5 | 6 | 7 | 8 |
|---|---|---|---|---|---|---|---|---|
| Ethylenediamine (g/L) | 5 | | | | | | | |
| Diethylene triamine (g/L) | | 5 | | | | | | |
| Triethylene tetramine | | | 5 | | | | | |
| Tetraethylene pentamine | | | | 5 | | | | |
| Pentaethylenehexamine | | | | | 5 | | | |
| Polyethyleneimine | | | | | | 5 | | |
| (molecular weight: 600) (g/L) | | | | | | | | |
| Polyethyleneimine | | | | | | | 5 | |
| (molecular weight: 1,200) (g/L) | | | | | | | | |
| Propylamine (g/L) | | | | | | | | 5 |

Using the conditioning agent described above, electroless copper plating and copper electroplating were performed according to the procedure as shown in Table 5. The percentage of the electroplating film formed on the surface of the resin molded article was measured to evaluate the deposition performance of the electroplating. After performing catalyst application, the amount of Pd adsorbed on the resin surface was measured according to the ICP emission spectrochemical analysis. Additionally, the surface resistance value (kΩ) of the resin surface obtained after electroless copper plating was measured. The results are shown in Table 7 below.

TABLE 7

| | Deposition | Adsorption | Resistance value of |
|---|---|---|---|
| | condition of the | amount of Pd on the | the resin surface |
| | copper sulfate | resin surface after | after electroless |
| Conditioning | electro-plating | catalyst application | copper plating |
| agent | film | (mg/dm²) | (kΩ) |
| 1 | Full | 0.2944 | 7.85 |
| | deposition | | |
| 2 | Full | 0.2875 | 8.45 |
| | deposition | | |
| 3 | Full | 0.2815 | 7.98 |
| | deposition | | |
| 4 | Full | 0.3179 | 5.31 |
| | deposition | | |
| 5 | Full | 0.3543 | 4.45 |
| | deposition | | |
| 6 | Full | 0.3871 | 4.81 |
| | deposition | | |
| 7 | Full | 0.4263 | 3.85 |
| | deposition | | |
| 8 | Full | 0.3831 | 4.43 |
| | deposition | | |
| Without | No deposition | 0.1188 | Unmeasurable due |
| conditioning | | | to exceedingly |
| | | | high value |

As is clear from the above results, in the pretreatment process using a manganate salt-containing etching solution, when the conditioning treatment is performed using an aqueous solution containing an amine compound as an active ingredient, the amount of the catalyst adsorbed on the resin surface is raised, which results in an improved deposition performance of the electroless plating, ensuring the production of a uniform electroplating film.

### Example 3

A flat plate (10 cm×5 cm×0.3 cm, surface area: about 1 dm²) made of an ABS resin (trade name: “CYCOLAC 3001M”; product of UMG ABS, Ltd.) was used as a substrate and held by a jig coated by a flexible vinyl chloride sol. The treatment according to an immersion method was conducted following the procedure as shown in Table 8 below, to thereby perform electroless plating and electroplating. Treatment agents shown in Table 9 below were used as activating agents. Washing was conducted between each step.

TABLE 8

| Treatment | Kind of treatment agent | | | Treatment condition | | |
|---|---|---|---|---|---|---|
| procedure | Component | Content | | Temperature | time | |
| Degreasing | Alkaline degreasing | 50 | g/L | 40° C. | 3 | min. |
| | solution (“ACE CLEAN | | | | | |
| | A-220”; produed by | | | | | |
| | Okuno Chemical | | | | | |
| | Industries Co., Ltd.) | | | | | |
| ↓ | | | | | | |
| Etching | Potassium permanganate | 0.5 | g/L | 65° C. | 10 | min. |
| | Sodium perchlorate | 5 | g/L | | | |
| | 98% Sulfuric acid | 250 | ml/L | | | |
| ↓ | | | | | | |
| Post-treatment | Glucose | 50 | g/L | 50° C. | 5 | min. |
| | 35% Hydrochloric acid | 150 | ml/L | | | |
| ↓ | | | | | | |
| Conditioning | Ethylenediamine | 5 | g/L | 25° C. | 1 | min. |
| ↓ | | | | | | |
| Pre-dipping | 35% Hydrochloric acid | 250 | ml/L | 25° C. | 1 | min. |
| ↓ | | | | | | |
| Catalyst | Palladium chloride | 330 | mg/L | 35° C. | 6 | min. |
| application | Stannous chloride | 35 | g/L | | | |
| | 35% Hydrochloric acid | 250 | ml/L | | | |
| | ↓ | | | | | |
| | Activating agent of Table 9 | | | 40° C. | 5 | min. |
| ↓ | | | | | | |
| Electroless | Electroless copper plating | | | 45° C. | 3 | min. |
| plating | (“CRP selector”; produced by Okuno | | | | | |
| | Chemical Industries Co., Ltd.) | | | | | |
| ↓ | | | | | | |
| Copper | Copper sulfate | 250 | g/L | | 1.5 | A/dm² |
| sulfate | 98% Sulfuric acid | 50 | g/L | | 5 | min. |
| electro- | Chlorine ion | 50 | ppm | | | |
| plating | CRP Copper MU (produced | 5 | ml/L | 25° C. | | |
| | by Okuno Chemical | | | | | |
| | Industries Co., Ltd.) | | | | | |
| | CRP Copper A (produced | 0.5 | ml/L | | | |
| | by Okuno Chemical | | | | | |
| | Industries Co., Ltd.) | | | | | |

TABLE 9

| | 1 | 2 | 3 | 4 | 5 | 6 | 7 |
|---|---|---|---|---|---|---|---|
| Formic acid (g/L) | 50 | | | | | | |
| Oxalic acid (g/L) | | 50 | | | | | |
| Tartaric acid(g/L) | | | 50 | | | | |
| Salicylic acid(g/L) | | | | 50 | | | |
| Potassium pyrophosphate (g/L) | | | | | 50 | | |
| Sodium hydrogencarbonate (g/L) | | | | | | 50 | |
| Boric acid (g/L) | | | | | | | 50 |

Using the activating agent described above, electroless copper plating and copper electroplating were performed according to the procedure as shown in Table 8. Thereafter, the percentage of the electroplating film formed on the surface of the resin molded article, and the presence or absence of the electroplating film on the surface of the jig were visually checked. The results are shown in Table 10.

TABLE 10

| | | Deposition of | Deposition of |
|---|---|---|---|
| | | electoplating on the | electroplating on |
| | | resin molded article | the jig |
| Activating | 1 | Full deposition | None |
| Agent | 2 | Full deposition | None |
| | 3 | Full deposition | None |
| | 4 | Full deposition | None |
| | 5 | Full deposition | None |
| | 6 | Full deposition | None |
| | 7 | Full deposition | None |

| | | |
|---|---|---|
| Without activating agent | Full deposition | Deposited |

As is clear from the above results, the electroplating deposition on the jig coated by a flexible vinyl chloride sol can be prevented without deteriorating the deposition performance of the plating on the surface of the resin to be plated, by applying a Pd catalyst with a catalyst application solution comprising an acidic mixed colloidal solution of palladium chloride and stannous chloride, and then activating with any one of activating agents 1 to 7.

1. A pretreatment process for electroless plating of a resin molded article, the pretreatment process comprising etching the resin molded article using an etching solution containing a manganate salt, and then bringing the resin molded article into contact with an aqueous solution containing a reducing compound and an inorganic acid.

2. The pretreatment process according to claim 1, wherein the etching solution containing a manganate salt is an aqueous solution containing 20 to 1,200 g/L of an inorganic acid, 0.01 to 40 g/L of a manganate salt, and 1 to 200 g/L of at least one member selected from the group consisting of halogen oxoacids, halogen oxoacid salts, persulfate salts, and bismuthate salts.

3. A post-treatment agent of a resin molded article etched with an etching solution containing a manganate salt, the agent comprising an aqueous solution containing a reducing compound and an inorganic acid.

4. A process for plating a resin molded article comprising the steps of:
(1) performing an etching treatment by bringing an etching solution containing a manganate salt into contact with the resin molded article;
(2) performing a post-treatment by bringing the resin molded article subjected to the etching treatment in step (1) into contact with a post-treatment agent comprising an aqueous solution containing a reducing compound and an inorganic acid;
(3) performing a surface conditioning by bringing the resin molded article subjected to the post-treatment in step (2) into contact with an aqueous solution containing an amine compound;
(4) applying an electroless plating catalyst after performing the surface conditioning in step (3); and
(5) performing electroless plating after applying the electroless plating catalyst in step (4).

5. The process according to claim 4, wherein the aqueous solution containing an amine compound used in step (3) above comprises at least one member selected from the group consisting of ethyleneamines represented by the formula: H₂N(CH₂CH₂NH)ₙH, wherein n is an integer of 1 to 5, polyethyleneimines, and propylamines represented by the formula: 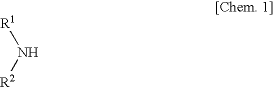
wherein R¹ is a propyl group or an aminopropyl group optionally having a substituent(s) on nitrogen atom, and R² is a propyl group, an aminopropyl group optionally having a substituent(s) on nitrogen atom, or a hydrogen atom.

6. The process according to claim 4, wherein the process for applying an electroless plating catalyst in step (4) above comprises bringing the resin molded article into contact with a mixed colloidal solution containing 0.01 to 0.6 g/L of palladium chloride, 1 to 50 g/L of stannous chloride, and 100 to 400 ml/L of 35% hydrochloric acid, and then bringing the article into contact with an aqueous solution containing at least one member selected from the group consisting of carboxylic acids, carboxylic acid salts, phosphorus compounds, carbonic acid salts, and a boric acid.

7. A process for plating a resin molded article comprising performing electroless plating by the process according to claim 4, and then performing electroplating.

8. The plating process according to claim 4, wherein the manganate salt-containing etching solution is an aqueous solution containing 20 to 1,200 g/L of an inorganic acid, 0.01 to 40 g/L of a manganate salt, and 1 to 200 g/L of at least one member selected from the group consisting of halogen oxoacids, halogen oxoacid salts, persulfate salts, and bismuthate salts.

9. A surface conditioning agent for use in a process for plating a resin molded article comprising an etching treatment step using a manganate salt-containing etching solution, the agent comprising an aqueous solution containing an amine compound.

10. An activating agent for use in a catalyst application step of a process for plating a resin molded article comprising an etching treatment step using a manganate salt-containing etching solution, the agent comprising an aqueous solution containing at least one member selected from the group consisting of carboxylic acids, carboxylic acid salts, phosphorus compounds, carbonic acid salts, and a boric acid.
